(19) United States
(12) Patent Application Publication
(10) Pub. No.: US 2006/0178767 A1
(43) Pub. Date: Aug. 10, 2006

(54) Systems and methods for inspection control

(75) Inventors: Song-Bor Lee, Hsinchu City (TW); Yu-Ching Chang, Dava Township (TW); Shih-Chieh Liao, Jungli City (TW); Jacky Chen, Hsinchu City (TW); Joey Chen, Hsinchu City (TW); Tzu-Jeng Hsu, Taipei City (TW); Ving-Ching Lee, Fongyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/051,423

(22) Filed: Feb. 4, 2005

(51) Int. Cl. G06F 19/00

(52) U.S. Cl. 700/109; 700/115

(57) ABSTRACT

Dynamic sampling systems for fabrication with inspection control are provided. In embodiments of a fabrication system comprising a processing tool, inspection tool, and a controller, the processing tool performs a fabrication process on a workpiece associated with identification information. The inspection tool performs an inspection step on the workpiece. The controller, coupled to the processing and inspection tools, determines whether the processing tool corresponds to an inspection result obtained during a preset time period, and determines whether the workpiece is to be inspected by the inspection tool accordingly.

### BACKGROUND

This invention relates generally to semiconductor manufacturing, and more particularly, to methods and systems for performing dynamic sampling of semiconductor wafers for inspection during manufacture.

Generally, hundreds of processing steps are performed on wafers using various processing tools. During manufacture, all or some wafers on a production line are inspected. Results of the inspection may be used for yield analysis, tool adjustment, or other application.

Typically, inspection tool capacity is much lower than that of corresponding processing tools. Bottlenecks may occur in an inspection step because of an improper sampling of wafers for the inspection.

Conventionally, wafer lots are sampled according to the last character in the identification number thereof. For example, wafer lots having “0” and “5” as the last character in the IDs thereof may be selected for inspection at a preset processing stage. When a wafer lot is processed by a tool, it is determined whether the wafer lot is to be inspected. It is determined whether the last character of the lot ID is “0” or “5”, and if so, the wafer lot is added into a queue line for an inspection tool for inspection performing, otherwise the wafer lot is sent to another processing tool for successive processing.

The conventional method, however, focuses on the fix ratio of sampling, such that several problems rise therefrom. This sampling mechanism selects wafer lots with particular IDs for inspection, even though the queue line may be too long for the capacity of the inspection tool. In this case, a bottleneck occurs in the inspection stage, requiring manual removal of wafer lots from the queue. When the inspection tool has excess capacity, the sampling mechanism cannot raise the sampling rate dynamically, leaving the inspection tool idle. Additionally, wafer lots selected for inspection may not distributed evenly among several processing tool sets. For example, a processing station may comprise tools A, B, and C for performing a processing step. During a 24-hour period, 10 wafer lots are taken as samples for inspection, and all selected wafer lots are processed by tool C. Status of tool C can be monitored using the inspection results, while there is no inspection result pertaining to tools A and B during the 24-hour period.

### SUMMARY

Systems for fabrication with inspection control are provided. In embodiments of a fabrication system comprising a processing tool, inspection tool, and a controller, the processing tool performs a fabrication process on a workpiece associated with identification information. The inspection tool performs inspection on the workpiece. The controller, coupled to the processing and inspection tools, determines whether the processing tool corresponds to an inspection result obtained during a preset time period, and determines whether the workpiece is to be inspected by the inspection tool according to the workpiece ID, capacity and operation information of the inspection tool, and the inspection result corresponding to the processing tool.

Also disclosed are methods of inspection control. In an embodiment of such a method, identification information associated with a workpiece processed by a processing tool is provided. Capacity and operation information pertaining to an inspection tool is also provided. It is determined whether the processing tool corresponds to an inspection result obtained during a preset time period. It is then determined whether the workpiece is to be inspected by the inspection tool according to the workpiece ID, capacity and operation information of the inspection tool, and the inspection result corresponding to the processing tool.

Various methods may take the form of program code embodied in a tangible media. When the program code is loaded into and executed by a machine, the machine becomes an apparatus for practicing the invention.

### DESCRIPTION OF THE DRAWINGS

The invention can be more fully understood by reading the subsequent detailed description and examples with references made to the accompanying drawings, wherein:

FIG. 1 is a schematic diagram showing an embodiment of a fabrication system capable of inspection control;

FIG. 2 is a flowchart of an embodiment of an inspection initialization process in an inspection control method; and

FIG. 3 is a flowchart of an embodiment of an inspection skipping process in an inspection control method.

### DETAILED DESCRIPTION

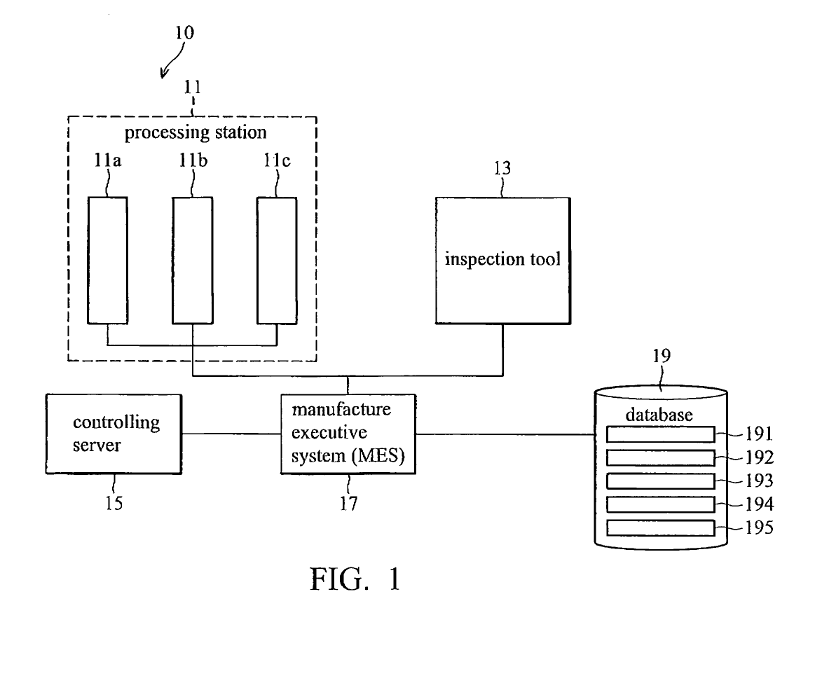

Exemplary embodiments of the invention are now described with reference to FIGS. 1 through 3, applied here to controlling inspection of wafers during manufacture. While some embodiments of the invention are applied with wafers, it is understood that other workpiece subjects requiring inspection during manufacture may be readily substituted.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic diagram of an embodiment of a fabrication system 10 capable of inspection control. As shown in FIG. 1, fabrication system 10 comprises a processing station 11, inspection tool 13, control server 15, manufacture executive system (MES) 17, and a database 19. Tools in the processing station 11 are capable of performing fabrication processes on wafer lots. The processing station 11 comprises tools 11a-11c having similar manufacturing capability, which require frequent inspection on the wafer processed thereby. Each wafer lot associates with identification information, such as a lot ID. The inspection tool 13 performs inspection on the wafer lots processed by the processing station 11. Both the inspection tool 13 and the processing station 11 are connected to and controlled by the MES 17. The MES 17 determines whether a particular wafer lot processed by the processing station 11 requires inspection according to control server 15. The control server 15, coupled to the MES 17, determines whether a wafer lot processed by the processing station 11 is to be inspected by the inspection tool 13. When one of the tools of the processing station 11 accomplishes a processing step for a wafer lot, the control server 15 is triggered to perform an inspection initialization process. The inspection initialization process determines whether an inspection process is required for the particular wafer lot. In addition, to ensure that wafer lots queued for the inspection tool 13 do not exceed the capacity thereof, the control server 15 periodically performs an inspection skipping process, checking whether a wafer lot is required to bypass the inspection step.

In the inspection initialization process, it is determined whether the wafer lot is identified as an “inspection-required lot” according to a preset list of wafer lots. The designated lot may be determined according to the lot ID thereof, recipe used by tool for processing the wafer lot, or other relevant information.

In the inspection skipping process, it is determined whether the wafer lot is identified as a “skipping-required lot” according to a preset list of wafer lots. The designated lot may be determined according to the lot ID thereof, recipe used by tool for processing the wafer lot, or other relevant information.

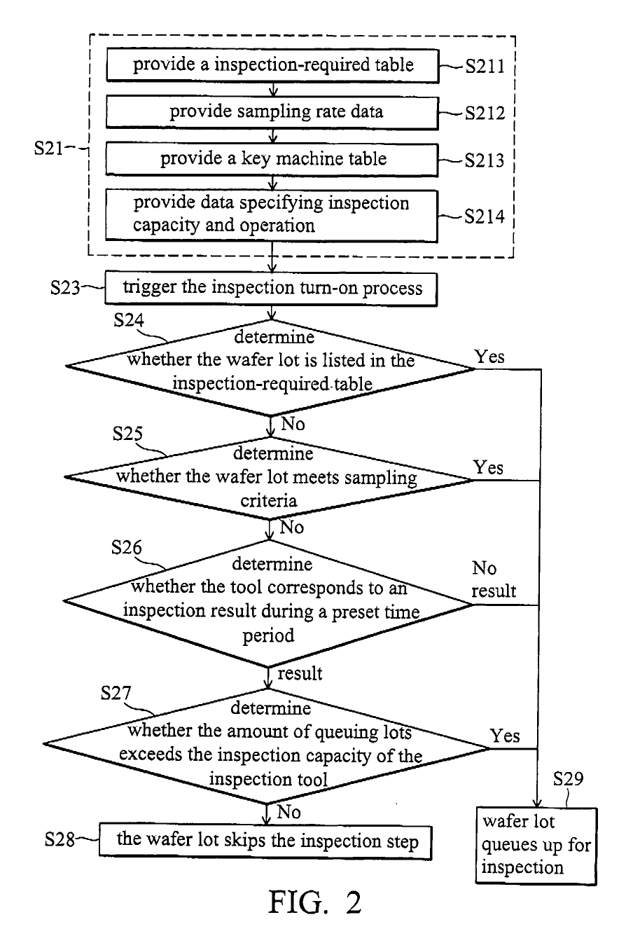

The processing algorithm implemented for the inspection initialization process in control server 15 is detailed in the flowchart of FIG. 2. Relevant information is provided and stored in database 19 in step S21. In step S211, inspection-required table 191 is provided. The inspection-required table 191 specifies a plurality of wafer lots designated as “inspection required”. The inspection-required table may be determined according to the lot ID thereof, recipe used for processing, or other relevant information. In step S212, data specifying sampling rate is provided, which may be stored in the sampling rate table 192. The sampling rate specifies the sampling setting, such as sampling ratio and rules, of wafer lots for inspection. For example, wafer lots are sampled according to the last character in the identification number thereof, wherein wafer lots having “0” and “5” as the last character in the ID thereof may be selected for inspection at a preset processing stage. The sampling ratio and sampling rule may be defined by a user. In step S213, a key machine table is provided, which may be the key machine table 193. The key machine table records equipment ID for each tool in the processing station, and inspection results corresponding to each of the tools. The key machine table may be used as a reference to determine whether tools within a processing station are evenly inspected during a preset time period. In step S214, data specifying inspection capacity and operation is provided, which may be the inspection tool set table 194. The inspection tool set table 194 comprises equipment ID for the inspection tool 13, the number of queued lots thereof, and a preset limit for the queued amount. The inspection tool set table 194 may be used as a reference to determine whether the number of queued lots exceeds the inspection capacity of the inspection tool.

When a wafer lot is processed by one of tools 11a-11c, the control server is triggered to perform the inspection initialization process (step S23). The wafer lot is identified with a lot ID, associated with a record specifying an equipment ID of a processing tool by which the wafer lot has been processed. In step S24, the lot ID and the inspection-required table 191 are compared to determine whether the wafer lot is listed in the inspection-required table 191. If the lot ID is listed in the inspection-required table 191, the method proceeds to step S29, the corresponding wafer lot is added into the queue of the inspection tool 13, and otherwise, the method proceeds to step S25. In step S25, the lot ID is checked according to the sampling rate table 192 to determine whether the corresponding wafer lot meets sampling criteria. If the lot ID meets the sampling setting, the method proceeds to step S29, the corresponding wafer lot is put into the queue of the inspection tool 13, and otherwise, the method proceeds to step S26. In step S26, the lot ID and associated equipment ID are checked according to the key machine table 193 to determine whether the tool having processed the wafer lot corresponds to an inspection result during a preset time period, for example a 24-hour period. If the equipment ID associated with the lot ID corresponds to an inspection result obtained during a 24-hour period, the method proceeds to step S27, otherwise to step S29. In step S27, it is determined whether the number of queued lots exceeds the inspection capacity of the inspection tool according to inspection tool set table 194. The inspection capacity of the inspection tool is specified by a preset value stored in the inspection tool set table 194. If the number of queued lots exceeds the preset value, the method proceeds to step S26, otherwise to step S29. In step S28, the wafer lot skips the inspection step and is sent to a tool for processing. In step S29, the corresponding wafer lot is added into the queue of the inspection tool 13.

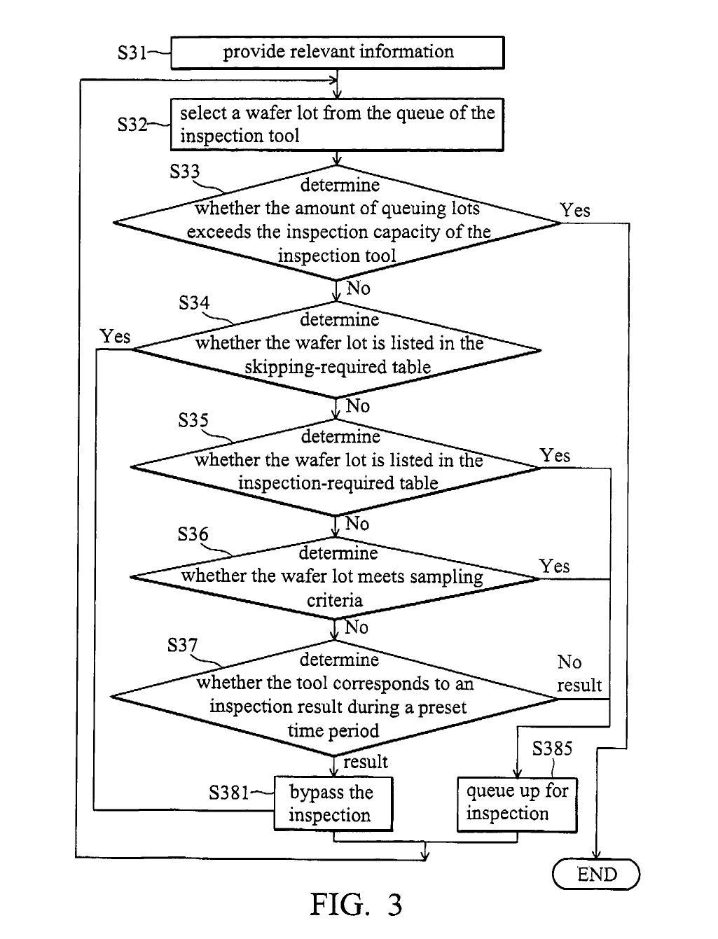

The processing algorithm implemented for the inspection skipping process in control server 15 is detailed in the flowchart of FIG. 3. Relevant information is provided and stored in database 19 in step S31. The inspection-required table 191, sampling rate table 192, key machine table 193, and tool set table 194 are provided here. Additionally, a skipping-required table 195 is provided. The skipping-required table 195 specifies a plurality of wafer lots designated as “skipping-required”. The skipping-required table 195 may be determined according to the lot ID thereof, recipe used for processing, or other relevant information.

The inspection skipping process is performed periodically. The time period for performing the inspection skipping process is predetermined. When the inspection skipping process is triggered, a wafer lot queued for the inspection tool is selected (step S32). The selection step may be executed according to characteristics corresponding to the wafer lot, such as priority setting, queue time record, or other setting. In step S33, it is determined whether the number of queued lots exceeds the inspection capacity of the inspection tool according to inspection tool set table 194. The inspection capacity of the inspection tool is specified by a preset value stored in the inspection tool set table 194. If the number of queued lots exceeds the preset value, the method proceeds to step S34, otherwise to an end. In step S34, the lot ID and the skipping-required table 195 are compared to determine whether the wafer lot is listed in the skipping-required table 195. If the lot ID is listed in the skipping-required table 195, the method proceeds to step S381, otherwise to step S35. In step S35, the lot ID and the inspection-required table 191 are compared to determine whether the wafer lot is listed in the inspection-required table 191. If the lot ID is listed in the inspection-required table 191, the method proceeds to step S385, otherwise the method proceeds to step S36. In step S36, the lot ID is checked according to the sampling rate table 192 to determine whether the corresponding wafer lot meets sampling criteria. If the lot ID meets the sampling setting, the method proceeds to step S385, the corresponding wafer lot queues up for inspection, otherwise the method proceeds to step SS381. In step S381, the wafer lot bypasses the inspection, and is sent to another processing tool for successive processing. In step S385, the wafer lot is queued for inspection.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A sampling method of inspection control, comprising:
providing identification information (ID) associated with a workpiece processed by a processing tool;
providing capacity and operation information pertaining to an inspection tool;
determining whether the processing tool corresponds to an inspection result obtained during a preset time period; and
determining whether the workpiece is to be inspected by the inspection tool according to workpiece ID, capacity and operation information of the inspection tool, and the inspection result corresponding to the processing tool.

2. The method of claim 1, wherein the workpiece comprises a wafer lot associated with a lot ID.

3. The method of claim 1, wherein the operation information of the inspection tool specifies sampling setting and queue length thereof.

4. The method of claim 1, further providing a record of inspection results, pertaining to the processing tool, obtained during the preset time period.

5. The method of claim 1, further sending the workpiece to subsequent processing when the workpiece is not selected for the inspection.

6. The method of claim 1, the dynaminc sampling further comprising:
determining whether the workpiece is designated for inspection according to the identification information thereof;
determining whether number of workpieces queued up at the inspection tool exceeds a preset volume.

7. The method of claim 6, wherein the inspection determination comprises comparing the identification information of the workpiece and a preset workpiece list.

8. The method of claim 6, wherein the inspection determination comprises determining whether the fixed ID's characters of the identification information is a preset number.

9. A fabrication system, comprising:
a processing tool performing a fabricating process on a workpiece associated with identification information;
an inspection tool performing an inspection step on the processed workpiece; and
a controller, coupled to the processing and inspection tools, determining whether the processing tool corresponds to an inspection result obtained during a preset time period, and determining whether the workpiece is to be inspected by the inspection tool according to the workpiece ID, capacity and operation information of the inspection tool, and the inspection result corresponding to the processing tool.

10. The system of claim 9, wherein the processing tool processes a wafer lot associated with a lot ID.

11. The system of claim 9, further comprising a storage device storing a preset sampling rate setting, processing tool list, inspection capacity data, inspection queue data, and a workpiece list.

12. The system of claim 11, wherein the operation information including throughput and tool sets that indicate the available capacity of the inspection tool specifies sampling setting and queue length.

13. The system of claim 11, wherein the storage device further stores a record of inspection results, pertaining to the processing tool, obtained during the preset time period.

14. The system of claim 11, further sending-the workpiece to subsequent processing when the workpiece is not selected for the inspection.

15. The system of claim 11, wherein the controller further determines whether the workpiece is designated for an inspection step according to the identification information thereof, and determines whether number of the workpieces queued at the inspection tool exceeds a preset volume.

16. The system of claim 15, wherein the controller further compares the identification information of the workpiece and the preset workpiece list.

17. The system of claim 15, wherein the controller further determines whether the last character of the identification information is a preset number.

18. The system of claim 15, further comprising a manufacturing executive system (MES) controlling operation of the processing and inspection tools according to the controller.
